(19) United States
(12) Patent Application Publication
(10) Pub. No.: US 2026/0213809 A1
(43) Pub. Date: Jul. 23, 2026

(54) WIRELESS, DEVICE, NETWORK NODE AND METHODS PERFORMED THEREIN FOR EXTENDED COVERAGE FOR RADIO REFERENCE SIGNALS

(71) Applicant: Telefonaktiebolaget LM Ericsson (PUBL), Stockholm (SE)

(72) Inventors: Mattias Frenne, UPPSALA (SE); Anders Landström, BODEN (SE)

(21) Appl. No.: 19/143,306

(22) PCT Filed: Dec. 22, 2023
(86) PCT No.: PCT/SE2023/051303

§ 371 Date: Jun. 25, 2025

Related U.S. Application Data
(60) Provisional application No. 63/477,580, filed on Dec. 29, 2022.

(51) Int. Cl. H04B 7/06; H04B 7/10; H04J 13/00

(52) U.S. Cl. CPC H04B 7/0626; H04B 7/10; H04J 13/004

(57) ABSTRACT

According to embodiments herein a method is provided and performed by a network node for handling communication in a wireless communication network. The network node transmits a pair of CSI-RS ports associated with different polarizations through different groups of power amplifiers, applying TD-OCC to maintain orthogonal on same resource elements. With repetition of OFDM symbols by each CSI-RS port, coverage of the network node can be extended.

### TECHNICAL FIELD

This disclosure relates to methods in a wireless communication system. In particular, the disclosure relates to Extended Coverage for Radio Reference Signals.

### BACKGROUND

Fifth generation (5G) New Radio (NR) wireless networks use CP-OFDM (Cyclic Prefix Orthogonal Frequency Division Multiplexing) in both downlink (i.e. from a network node, gNB, or base station, to a user equipment or UE) and uplink (i.e. from UE to gNB). Discrete Fourier transform (DFT) spread OFDM is also supported in the uplink. In the time domain, NR downlink and uplink are organized into equally-sized subframes of 1 ms each. A subframe is further divided into multiple slots of equal duration. The slot length depends on subcarrier spacing. For subcarrier spacing of Δf=15 kHz, there is only one slot per subframe and each slot consists of 14 OFDM symbols.

Data scheduling in NR is typically in slot basis where an example is shown in Error! Reference source not found. with a 14-symbol slot, where the first two symbols contain physical downlink control channel (PDCCH) and possibly data, and the rest contains physical shared data channel, either PDSCH (physical downlink shared channel) or PUSCH (physical uplink shared channel).

NR supports different subcarrier spacing values. The supported subcarrier spacing values (also referred to as different numerologies) are given by Δf=(15×2^{μ}) kHz where μ∈0,1,2,3,4. Δf=15 kHz is the basic subcarrier spacing. The slot duration at different subcarrier spacings is given by

$$\frac{1}{{2}^{μ}} ms .$$

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in Error! Reference source not found., where only one resource block (RB) within a 14-symbol slot is shown. One OFDM subcarrier during one OFDM symbol interval forms one resource element (RE).

Downlink (DL) PDSCH transmissions can be either dynamically scheduled, i.e., in each slot the gNB transmits downlink control information (DCI) over PDCCH (Physical Downlink Control Channel) about which UE data is to be transmitted to and which RBs in the current downlink slot the data is transmitted on, or semi-persistently scheduled (SPS) in which periodic PDSCH transmissions are activated or deactivated by a DCI. Different DCI formats are defined in NR for DL PDSCH scheduling including DCI format 1_0, DCI format 1_1, and DCI format 1_2.

Similarly, uplink (UL) PUSCH transmission can also be scheduled either dynamically or semi-persistently with uplink grants carried in PDCCH. NR supports two types of semi-persistent uplink transmission, i.e., type 1 configured grant (CG) and type 2 configured grant, where Type 1 configured grant is configured and activated by Radio Resource Control (RRC) while type 2 configured grant is configured by RRC but activated/deactivated by DCI. The DCI formats for scheduling PUSCH include DCI format 0_0, DCI format 0_1, and DCI format 0_2.

The new generation mobile wireless communication system (5G or NR) supports a diverse set of use cases and a diverse set of deployment scenarios. The later includes deployment at both low frequencies (100 s of MHz), similar to LTE today, and very high frequencies (mm waves in the tens of GHz). At high frequencies, propagation characteristics make achieving good coverage challenging. One solution to the coverage issue is to employ high-gain beamforming, typically in an analog manner, to achieve satisfactory link budget.

Note that terminology used herein such as gNB and UE should be considered non-limiting and does not imply a certain hierarchical relation between the two; in general “gNB” could be considered as device 1 and “UE” device 2, and these two devices communicate with each other over a radio channel. Alternatively, other terminology such as “gNodeB” can be used in place of “gNB” in different communication systems. Herein, we also focus on wireless transmissions in the downlink, while particular embodiments are equally applicable in the uplink.

NR uses OFDM in the downlink and uplink. The basic NR downlink physical resource can thus be seen as a time-frequency grid as illustrated in FIG. 3, where each resource element corresponds to one OFDM subcarrier during one OFDM symbol interval. Although a subcarrier spacing of Δf=15 kHz is shown in FIG. 3, different subcarrier spacing values are supported in NR. The supported subcarrier spacing values (also reference to as different numerologies) in NR are given by Δf=(15× 2^{α}) kHz where a is a non-negative integer.

In the time domain, downlink transmissions are organized into radio frames of 10 ms, each radio frame consisting of ten equally-sized subframes of length T_{subframe}=1 ms which is illustrated in FIG. 4. While a subframe is always 1 ms, in NR, a slot length for a (15×2^{α}) kHz subcarrier spacing is y 1/2^{α} ms.

Furthermore, the resource allocation is typically described in terms of resource blocks, where a resource block corresponds to one slot (14 OFDM symbols) in the time domain and 12 contiguous subcarriers in the frequency domain. Resource blocks are numbered in the frequency domain, starting with 0 from one end of the bandwidth part.

Downlink transmissions are dynamically scheduled, i.e., in each subframe the gNB transmits control information about to which terminals data is transmitted and upon which resource blocks the data is transmitted, in the current downlink subframe. This control signaling is typically transmitted in the first 1, 2, 3 or 4 OFDM symbols in each slot in NR.

### Channel State Information Reference Symbols (CSI-RS)

NR uses a reference symbol sequence and mapping to the resource element grid to estimate channel state information, the CSI-RS. The sequence and mapping is known to both the transmitter and the receiver, and thereby the receiver can measure the impact of the channel, because what is transmitted is known to the receiver.

By measuring on a CSI-RS, a UE can estimate the effective channel the CSI-RS is traversing including the radio propagation channel and antenna gains and any eventual beamforming operation, such as transmitting the same signal from multiple physical transmitter antennas but with an antenna dependent phase shift.

In more mathematical rigor this implies that if a known CSI-RS signal x is transmitted, a UE can estimate the coupling between the transmitted signal and the received signal (i.e., the effective channel). Thus, if no virtualization or transmit precoding is performed in the transmission, the received signal y can be expressed as y=Hx+e and the UE can estimate the effective channel H. Up to 32 CSI-RS ports can be configured for a NR UE. That is, the UE can estimate the channel from up to thirty-two transmit antenna ports. In this case, the x is a 32x1 vector where each element represent the sequence symbol transmitted from an unique CSI-RS antenna port and H is then a n_rx×32 channel matrix, where n_rx is the number of receive antennas at the receiver.

An antenna port is equivalent to a reference signal resource that the UE shall use to measure the channel. Thus, a gNB with two antennas could define two CSI-RS ports, where each port is defined by a set of resource elements in the OFDM time frequency grid within a subframe or slot. The base station transmits each of the two reference signals from each of the two antennas so that the UE can measure the two radio channels and report channel state information back to the base station based on these measurements. In NR, CSI-RS resources with 1,2,4,8,12,16,24 and 32 ports are supported.

The sequence used for CSI-RS is r(m) and is defined by

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) )$$

where the pseudo-random sequence c(i) is defined in clause 5.2.1 of 3GPP TS 38.211. The pseudo-random sequence generator shall be initialised with

$${c}_{init} = ( {2}^{10} ( {N}_{symb}^{slot} {n}_{s , f}^{μ} + l + 1 ) ( 2 {n}_{ID} + 1 ) + {n}_{ID} ) {mod 2}^{31}$$

at the start of each OFDM symbol where n is the slot number within a radio frame, l is the OFDM symbol number within a slot, and n_{ID} equals the higher-layer parameter scramblingID or sequence GenerationConfig.

There are 18 different CSI-RS resource configurations in NR, where each have a specific number of ports X. See Table 1 below. Code division multiplexing (CDM) is used to separate multiple CSI-RS ports that map to the same resource elements in the OFDM grid. CDM groups use an orthogonal cover code (OCC), for example [1 1] and [1-1] are two OCC codes of length 2 which are mutually orthogonal. These can thus be used to separate two CSI-RS ports that use the same resource elements in the OFDM grid. The receiver needs to de-spread the OCC with [1-1] and [1 1] respectively to obtain a measure of the channel for each of the two CSI-RS ports.

CDM groups can be defined in one OFDM symbol and extend across multiple subcarriers, denoted (frequency domain CDM) FD-CDM. CDM groups can alternatively be defined in multiple OFDM symbol and within one subcarrier, denoted (time domain CDM) TD-CDM although this is not used for CSI-RS in NR. For large number of ports, a CDM group can extend both time and frequency (CDM-FD-TD).

When code division multiplexing (CDM) is applied, the index kᵢ indicates the first subcarrier in the PRB that is used for mapping the CSI-RS sequence to resource elements, where the second subcarrier is kᵢ+1. This set (kᵢ, kᵢ+1) of two subcarriers is associated with a CDM group j, where a CDM group covers 1, 2 or 4 OFDM symbols. The index l_{i′}, or l_{i′}+1, indicates the first OFDM symbol within the slot that is associated with a CDM group. Note that kᵢ and l_{i′} are parameters signalled from gNB to UE by RRC signalling when configuring the CSI-RS resource.

When CDM is applied, the size of a CDM group, L, is either 2, 4 or 8 (which also equals the number of CSI-RS ports multiplexing in the CDM group) and the total number of CDM groups is given by the number of (kᵢ, l_{i′}), (kᵢ, l_{i′}+1) pairs given by the configuration. A CDM group can thus refer to a set of 2, 4 or 8 antenna ports, where the set of 2 antenna ports occurs when only CDM in frequency-domain over two adjacent subcarriers is considered (FD-CDM2).

In NR, CSI-RS ports are numbered within a CDM group first and then across CDM groups j, p=3000+p′, where p′=s+j·L with s=0,1, . . . , L−1.

Ports are sometimes numbered by excluding the value “3000”, meaning that ports are implicitly indicated by p′. For example, CSI-RS resource configuration given by row 4 in Table 1 has two CDM groups (j=0,1) of size L=2, where the ports 3000 and 3001 maps to the CDM group indicated by k₀ and the ports 3002 and 3003 maps to the CDM group indicated by k₀+2.

TABLE 1
CSI-RS resource configurations

| | Ports | Density | cdm- | | CDM group | | |
|---|---|---|---|---|---|---|---|
| Row | X | ρ | Type | (k̅, l̅) | index j | k′ | l′ |
| 1 | 1 | 3 | noCDM | (k₀, l₀), (k₀ + 4, l₀), (k₀ + 8, l₀) | 0, 0, 0 | 0 | 0 |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), (k₃, l₀) | 0, 1, 2, 3 | 0, 1 | 0 |
| 7 | 8 | 1 | fd-CDM2 | (k₀, l₀), (k₁, l₀), (k₀, l₀ + 1), (k₁, l₀ + 1) | 0, 1, 2, 3 | 0, 1 | 0 |
| 8 | 8 | 1 | cdm4- | (k₀, l₀), (k₁, l₀) | 0, 1 | 0, 1 | 0, 1 |
| | | | FD2-TD2 | | | | |
| 9 | 12 | 1 | fd-CDM2 | (k₀, l₀), (k₁, l₀), (k₂, l₀), (k₃, l₀), (k₄, l₀), | 0, 1, 2, 3, 4, | 0, 1 | 0 |
| | | | | (k₅, l₀) | 5 | | |
| 10 | 12 | 1 | cdm4- | (k₀, l₀), (k₁, l₀), (k₂, l₀) | 0, 1, 2 | 0, 1 | 0, 1 |
| | | | FD2-TD2 | | | | |
| 11 | 16 | 1, 0.5 | fd-CDM2 | (k₀, l₀), (k₁, l₀), (k₂, l₀), (k₃, l₀), (k₀, l₀ + 1), | 0, 1, 2, 3, 4, | 0, 1 | 0 |
| | | | | (k₁, l₀ + 1), (k₂, l₀ + 1), (k₃, l₀ + 1) | 5, 6, 7 | | |
| 12 | 16 | 1, 0.5 | cdm4- | (k₀, l₀), (k₁, l₀), (k₂, l₀), (k₃, l₀) | 0, 1, 2, 3 | 0, 1 | 0, 1 |
| | | | FD2-TD2 | | | | |
| 13 | 24 | 1, 0.5 | fd-CDM2 | (k₀, l₀), (k₁, l₀), (k₂, l₀), (k₀, l₀ + 1), | 0, 1, 2, 3, | 0, 1 | 0 |
| | | | | (k₁, l₀ + 1), (k₂, l₀ + 1), (k₀, l₁), (k₁, l₁), | 4, 5, 6, 7, | | |
| | | | | (k₂, l₁), (k₀, l₁ + 1), (k₁, l₁ + 1), (k₂, l₁ + 1) | 8, 9, 10, 11 | | |
| 14 | 24 | 1, 0.5 | cdm4- | (k₀, l₀), (k₁, l₀), (k₂, l₀), (k₀, l₁), (k₁, l₁), | 0, 1, 2, 3, 4, | 0, 1 | 0, 1 |
| | | | FD2-TD2 | (k₂, l₁) | 5 | | |
| 15 | 24 | 1, 0.5 | cdm8- | (k₀, l₀), (k₁, l₀), (k₂, l₀) | 0, 1, 2 | 0, 1 | 0, 1, |
| | | | FD2-TD4 | | | | 2, 3 |
| 16 | 32 | 1, 0.5 | fd-CDM2 | (k₀, l₀), (k₁, l₀), (k₂, l₀), (k₃, l₀), (k₀, l₀ + 1), | 0, 1, 2, 3, 4, | 0, 1 | 0 |
| | | | | (k₁, l₀ + 1), (k₂, l₀ + 1), (k₃, l₀ + 1), (k₀, l₁), | 5, 6, 7, 8, | | |
| | | | | (k₁, l₁), (k₂, l₁), (k₃, l₁), (k₀, l₁ + 1), | 9, 10, 11, 12, | | |
| | | | | (k₁, l₁ + 1), (k₂, l₁ + 1), (k₃, l₁ + 1) | 13, 14, 15 | | |
| 17 | 32 | 1, 0.5 | cdm4- | (k₀, l₀), (k₁, l₀), (k₂, l₀), (k₃, l₀), (k₀, l₁), | 0, 1, 2, 3, 4, | 0, 1 | 0, 1 |
| | | | FD2-TD2 | (k₁, l₁), (k₂, l₁), (k₃, l₁) | 5, 6, 7 | | |
| 18 | 32 | 1, 0.5 | cdm8- | (k₀, l₀), (k₁, l₀), (k₂, l₀), (k₃, l₀) | 0, 1, 2, 3 | 0, 1 | 0, 1 |
| | | | FD2-TD4 | | | | 2, 3 |

The 3GPP specifications for NR, TS 38.211 v16.0,0 states that for each CSI-RS configured, the UE shall assume the sequence r(m) being mapped to resources elements (k,l)_{p,μ} according to

$${a}_{k , l}^{( p , μ )} = {β}_{CSIRS} {w}_{f} ( {k}^{′} ) \cdot {w}_{t} ( {l}^{′} ) \cdot {r}_{l , {n}_{s , f}} ( {m}^{′} )$$

$${m}^{′} = ⌊ n α ⌋ + {k}^{′} + ⌊ \frac{\overline{k} ρ}{{N}_{sc}^{RB}} ⌋$$

$$k = {nN}_{sc}^{RB} + \overline{k} + {k}^{′}$$

$$l = \overline{l} + {l}^{′}$$

$$α = \{ \text{} \begin{matrix}ρ & for X = 1 \\ 2 ρ & for X > 1\end{matrix} \text{}$$

$$n = 0 , 1 , …$$

when the resource element (k,l)_{p,μ} is within the resource blocks occupied by the CSI-RS resource for which the UE is configured.

From this expression, it is possible to deduce (when CDM is applied) that for a given CSI-RS resource (row in Table 1) within a given OFDM symbol (fixed l), an antenna port p is mapped to two adjacent subcarriers using two samples from the sequence r(m′) where two adjacent values of m′ is used since m′ depends on k′=0,1. The values of k̅, ρ and X are given by RRC configuration, and the parameters w_{f}(k′) and wₜ(l′) are given by Table 2 below, where table index is related to port number as (3000−p) modulus L. For a CDM group of size L=2,4,8, the corresponding values on l′ are l′=0, l′=0,1, l′=0,1,2,3.

TABLE 2
OCC parameters

| Index | [w_{f}(0) w_{f}(1)] | [wₜ(0) wₜ(1) wₜ (2) wₜ(3)] |
|---|---|---|
| 0 | [+1 +1] | [+1 +1 +1 +1] |
| 1 | [+1 −1] | [+1 +1 +1 +1] |
| 2 | [+1 +1] | [+1 −1 +1 −1] |
| 3 | [+1 −1] | [+1 −1 +1 −1] |
| 4 | [+1 +1] | [+1 +1 −1 −1] |
| 5 | [+1 −1] | [+] +1 −1 −1] |
| 6 | [+1 +1] | [+1 −1 −1 +1] |
| 7 | [+1 −1] | [+1 −1 −1 +1] |

From this expression, it can also be observed that the mapping to resource elements do not depend on the CDM group. In other words, the same pseudo-random sequence is used in all the used CDM groups in OFDM symbol l.

This is illustrated in FIG. 5, where the four ports p0=3000 to p3=3003 are mapped to two CDM groups (L=2) and where the same sequence samples r(0) and r(1) are used in both CDM groups. This figure represents a CSI-RS resource configuration given by row 4 in Table 1, with first CDM group starting at subcarrier k₀ and the second starting at subcarrier k₀+2 (=k₁), both in the same OFDM symbol l₀.

In NR, closed loop MIMO transmission scheme is used where the UE estimates and feeds back the downlink CSI to the gNB. The gNB uses the feedback CSI to transmit downlink data to the UE. The CSI consists at least of a transmission rank indicator (RI), a precoding matrix indicator (PMI) and a channel quality indicator(s) (CQI). A codebook of precoding matrices is used by the UE to find out the best match between the estimated downlink channel Hₙ and a precoding matrix in the codebook based on certain criteria, for example, the UE throughput. The channel Hₙ is estimated based on a Non-Zero Power CSI reference signal (NZP CSI-RS) transmitted in the downlink.

The CQI/RI/PMI together provide the downlink channel state to the UE. This is also referred to as implicit CSI feedback because the estimation of Hₙ is not fed back directly. The CQI/RI/PMI can be wideband or subband depending on which reporting mode is configured.

The RI corresponds to a recommended number of streams that are to be spatially multiplexed and thus transmitted in parallel over the downlink channel. The PMI identifies a recommended precoding matrix codeword (in a codebook that contains precoders with the same number of rows as the number of CSI-RS ports) for the transmission, which relates to the spatial characteristics of the channel. The CQI represents a recommended transport block size (i.e., code rate) and LNR supports transmission of one or two simultaneous (on different layers) transmissions of transport blocks (i.e. separately encoded blocks of information) to a UE in a subframe. There is thus a relation between a CQI and an SINR of the spatial stream(s) over which the transport block or blocks are transmitted.

NR defines codebooks of up to 32 antenna ports. It supports both one dimensional (1D) and two-dimensional (2D) antenna arrays.

The codebook is designed assuming a specific antenna numbering (or rather port numbering scheme, where the mapping of antenna port to physical antenna is up to each deployment).

For a given P antenna ports, the precoding codebooks are designed so that the P/2 first antenna ports (e.g., port number 15, 16, 17, 18) should map to a set of co-polarized antennas and the P/2 last antenna ports (e.g., 19, 20, 21, 22) are mapped to another set of co-polarized antennas with an orthogonal polarization to the first set. This is thus targeting cross-polarized antenna arrays. See FIG. 6 for the case of 8 antenna ports.

Thus, the codebook principles for the rank 1 case are that a DFT “beam” vector is chosen for each set of P/2 ports and a phase shift with QPSK alphabet is used to co-phase the two sets of antenna ports. A rank 1 codebook is thus constructed as

$$( \begin{matrix}a \\ {ae}^{i ω}\end{matrix} ) ,$$

where a is a length P/2 vector that forms a beam for the first and second polarizations respectively and ω is a co-phasing scalar that co-phases the two orthogonal polarizations.

For NR, for a given P antenna ports in the CSI-RS resource, the precoding codebooks are designed so that the N/2 first antenna ports (e.g., the CSI-RS port number starts at 3000, then, 3001, 3002, 3003) should map to a first set of co-polarized antennas and the remaining N/2 antenna ports (e.g., 3004, 3005, 3006, 3007) are mapped to another set of co-polarized antennas, with an orthogonal polarization to the first set.

There currently exist certain challenges. For example, a problem exists with coverage for CSI-RS ports, especially for higher carrier frequencies such as band n104 (7 GHz) or even higher bands.

### SUMMARY

Certain aspects of the disclosure and their embodiments may provide solutions to these or other challenges. For example, particular embodiments identify a pair of CSI-RS antenna ports in a CSI-RS resource that are not transmitted through the same power amplifier. For beamformed CSI-RS this is typically the two ports transmitted in the same beam but using different transmit antenna polarizations.

According to one aspect of the disclosure, a method performed in a wireless device is provided. The wireless device obtains a CSI-RS configuration, indicating that a pair of CSI-RS ports of a transmitter being associated with different antenna polarization are multiplexed with different TD-OCCs. Therefore, the pair of CSI-RS ports with different antenna polarization can be separated by multiplexing TD-OCC. Then, according to the CSI-RS configuration, the wireless device receives the pair of CSI-RS ports being multiplexed with different TD-OCCs that share same resource elements.

According to another aspect of the disclosure, a method performed in a network node is provided. The network node transmits a CSI-RS configuration to a wireless device, indicating a pair of CSI-RS ports being associated with different antenna polarization are multiplexed with different TD-OCCs; and then, transmits, the pair of CSI-RS ports being multiplexed with different TD-OCCs that share same resource elements. The pair of CSI-RS with different polarization while being transmitted on the same resource elements can be separated by multiplexing TD-OCC.

In some further embodiments of the disclosure, the resource elements shared by the two CSI-RS ports belongs to consecutive OFDMs within a same subcarrier. If the multiplexed TD-OCC remains a length of 2, there can be two REs crossing two consecutive OFDMs, both of the REs being shared by the pair of CSI-RS ports. Since the two ports are transmitted repeatedly in two OFDM symbols, coverage of the transmitter of CSI-RS could be extended.

According to another aspect of the disclosure, a wireless device capable of performing the steps in the method described above is provided. The wireless device is configured to receive signals such as CSI-RS through wireless air interface and perform measurement on the received CSI-RS. According to another aspect of the disclosure, a network node capable of performing the steps in the method described above is provided. The network node is configured to transmit configuration to a wireless device regarding mapping of CSI-RS ports with time-frequency resource, and then generate and transmit reference signals via its Tx antenna. According to another aspect of the disclosure, a communication system comprising the wireless device and the network node is provided, too.

Based on this fact, particular embodiments realize that the two ports can be transmitted repeatedly in two OFDM symbols to double the received power of both CSI-RS port simultaneously without increasing the overhead. The ports are multiplexed with an OCC code in time, within a subcarrier, thus TD-CDM or equivalently TD-OCC is used. Thus, the two ports are using the same spatial beam (same beam directions) but different polarizations. Particular embodiments may be extended to a 2N-port CSI-RS resource using dual polarized antenna array, where N spatial dual polarized beams are created (N azimuth/elevation beam directions). Each of the N pairs of ports in the CSI-RS resource thus are thus multiplexed with an OCC over OFDM symbols (in time).

In general, particular embodiments ensure that CSI-RS ports that are mapped with the TD-OCC (TD-CDM) mapping are not transmitted through the same power amplifier. Typically ports belonging to different polarizations of the antenna arrays do not share the same power amplifier.

Certain embodiments may provide one or more of the following technical advantages. For example, particular embodiments may double the CSI-RS received power, which improves coverage of the CSI-RS. It is achieved in particular embodiments without changing 3GPP convention of mapping ports to antennas. Embodiments apply to more than 32 ports up to which the current LTE and NR specifications support, such as 64 or 128 ports.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of NR time-domain structure with 15 kHz subcarrier spacing according to the known art.

FIG. 2 illustrates basic NR physical resource grid in which one resource block is typically shown with a 14-symbol slot according to the known art.

FIG. 3 illustrates basic NR downlink physical resource in a time-frequency grid manner with 15 kHz subcarrier spacing.

FIG. 4 illustrates time-domain structure in NR according to the known art.

FIG. 5 illustrates sequence mapped to CDM groups with corresponding CSI-RS antenna ports according to 3GPP NR standard Release 15.

FIG. 6 shows an example of port numbering of 8 antenna ports using LTE port numbering (15,16,17, . . . ) according to the known art.

FIG. 7 illustrates an example that shows 4 CSI-RS ports transmit in which two ports with different polarization use separate groups of Power Amplifiers, according to some embodiments of the disclosure.

FIG. 8 is a flowchart performed by a use equipment point of view according to some embodiments of the disclosure.

FIG. 9 is a flowchart performed by a NodeB according to some embodiments of the disclosure. Figure QQ1 shows an example of a communication system QQ100 in accordance with some embodiments.

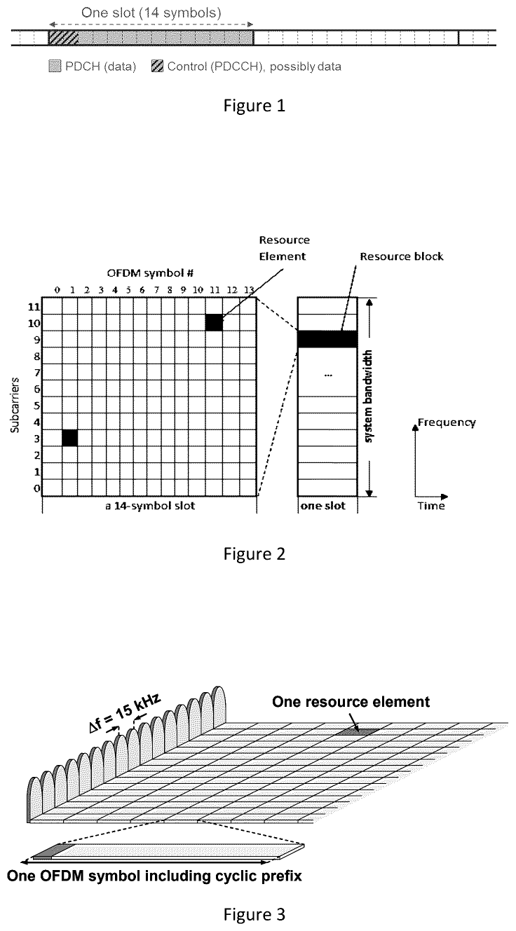

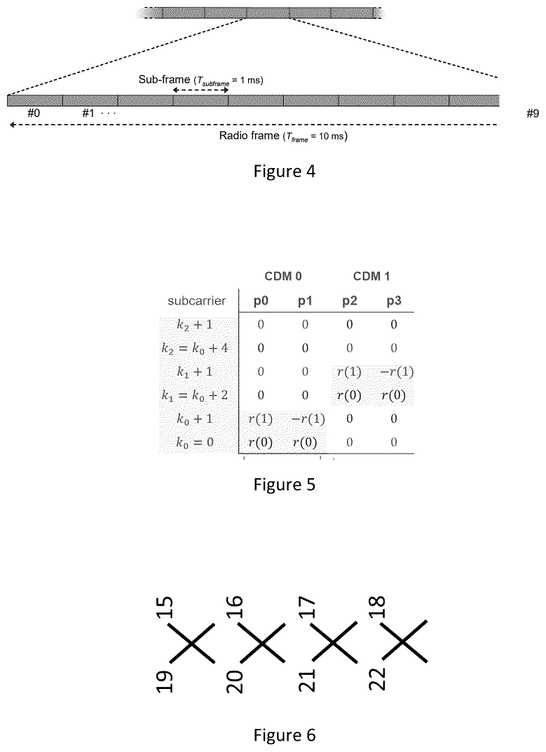

Figure QQ2 shows a UE QQ200 in accordance with some embodiments.

Figure QQ3 shows a network node QQ300 in accordance with some embodiments.

Figure QQ4 is a block diagram of a host QQ400, which may be an embodiment of the host QQ116 of Figure QQ1, in accordance with various aspects described herein.

Figure QQ5 is a block diagram illustrating a virtualization environment QQ500 in which functions implemented by some embodiments may be virtualized.

Figure QQ6 shows a communication diagram of a host QQ602 communicating via a network node QQ604 with a UE QQ606 over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

According to one aspect of the disclosure, a method performed by a wireless device is provided. For sake of simplicity, a User Equipment (UE) is used to describe embodiments as an example of the wireless device hereafter. A UE obtains (S810) a CSI-RS configuration from a network node, indicating that a pair of CSI-RS ports of the network node being associated with different antenna polarizations will be multiplexed with different TD-OCCs. Then, the UE receives (S820) the pair of CSI-RS ports being multiplexed with different TD-OCCs that share same resource elements, according to the CSI-RS configuration. The pair of CSI-RS ports are separated and maintained orthogonal by multiplexing TD-OCC.

In particular, the pair of CSI-RS ports are CSI-RS port n and CSI-RS port n+N/2, where N is a total number of CSI-RS ports of the transmitter and N is an integer larger than 4. According to the current NR or LTE specification, N could be up to 32. The embodiments described in the disclosure can support more than 32 port.

In an embodiment, the shared resource elements belong to consecutive OFDM symbols while sharing a same subcarrier. With a length of 2, TD-OCC can be multiplexed with the pair of CSI-RS ports in 2 consecutive OFDMs.

After receiving those CSI-RS ports, the UE performs measurement and can report to the network node with information of channel quality based on measurement result.

According to another aspect of the disclosure, a method performed by a network node is provided. For sake of simplicity, a NodeB (NB) is used to describe embodiments as an example of the network node hereafter. A NB transmits (S910) a CSI-RS configuration to a wireless device, indicating a pair of CSI-RS ports being associated with different antenna polarizations are multiplexed with different TD-OCCs. Then, it transmits (S920) the pair of CSI-RS ports being multiplexed with different TD-OCCs that share same resource elements.

In particular, the pair of CSI-RS ports are CSI-RS port n and CSI-RS port n+N/2, where N is a total number of CSI-RS ports of the transmitter and N is an integer larger than 4. According to the current NR or LTE specification, N could be up to 32. The embodiments described in the disclosure can support more than 32 port.

In an embodiment, the pair of CSI-RS ports are transmitted through different power amplifiers, or different groups of power amplifiers. One of the pair is transmitted through all power amplifiers in one PA group, while the other is transmitted through all power amplifiers in anther PA group. Because those 2 ports use different power amplifiers, coverage gain can be achieved by transmitted multiple times in multiple OFDM symbols.

In a further embodiment, the shared resource elements belong to consecutive OFDM symbols while sharing a same subcarrier. With a length of 2, TD-OCC can be multiplexed with the pair of CSI-RS ports in 2 consecutive OFDMs.

Particular embodiments ensure that CSI-RS ports that are mapped with the TD-OCC (TD-CDM) mapping are not transmitted through the same power amplifier. Typically, ports belonging to different polarizations of the antenna arrays do not share the same power amplifier.

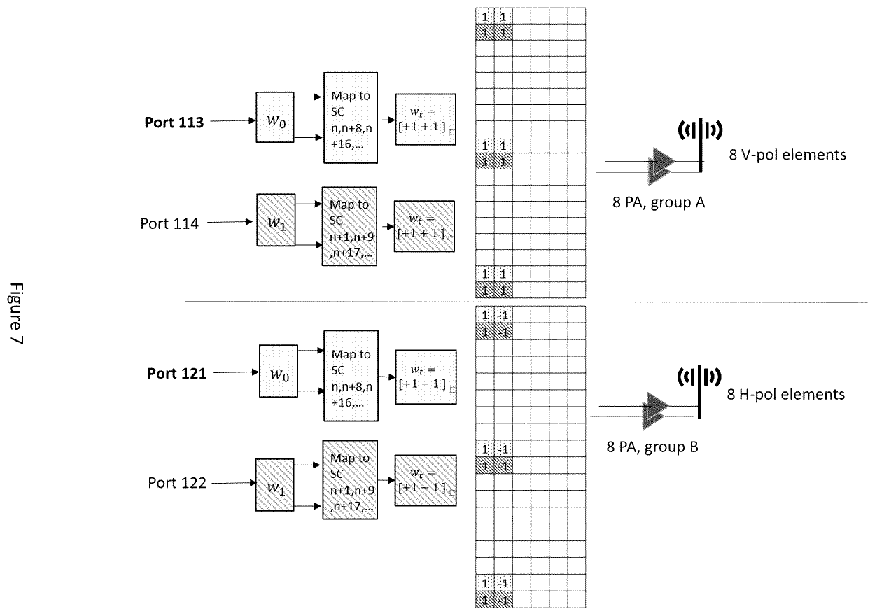

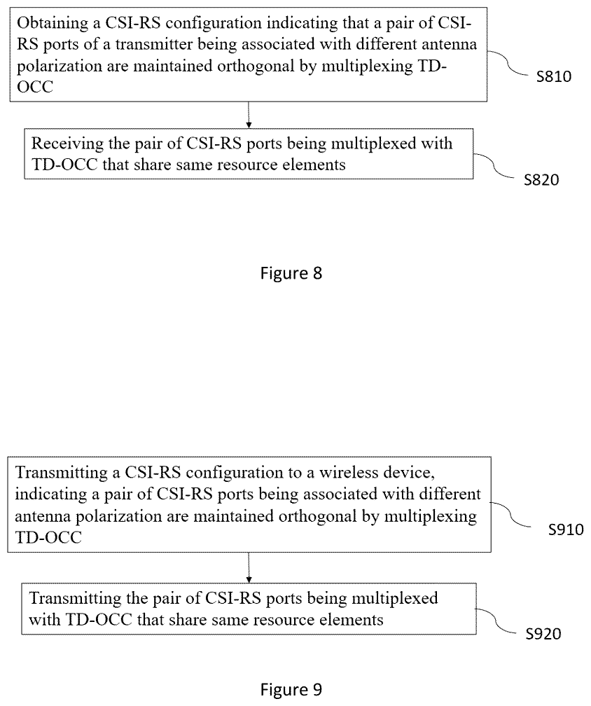

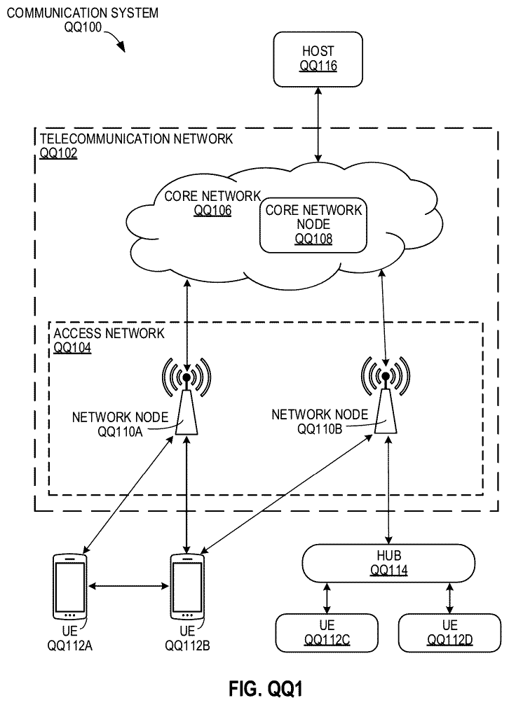

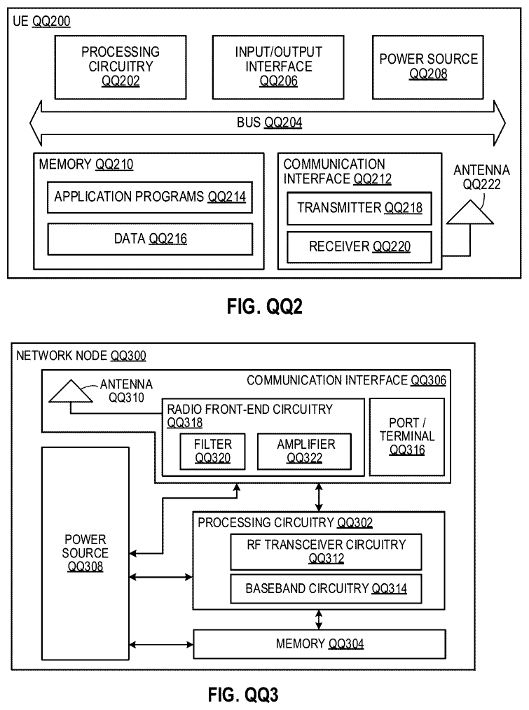

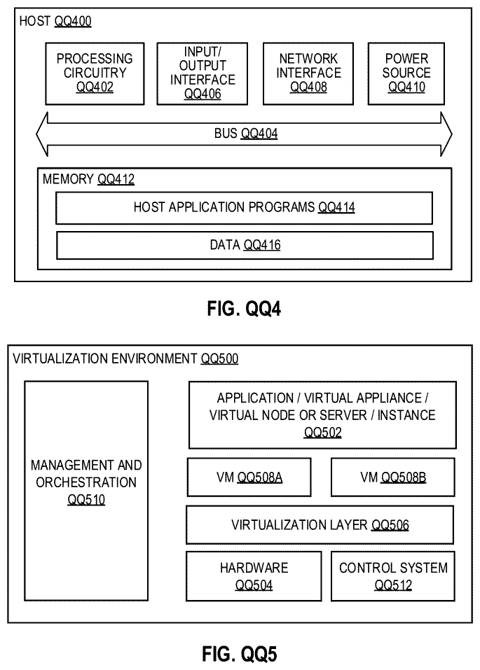

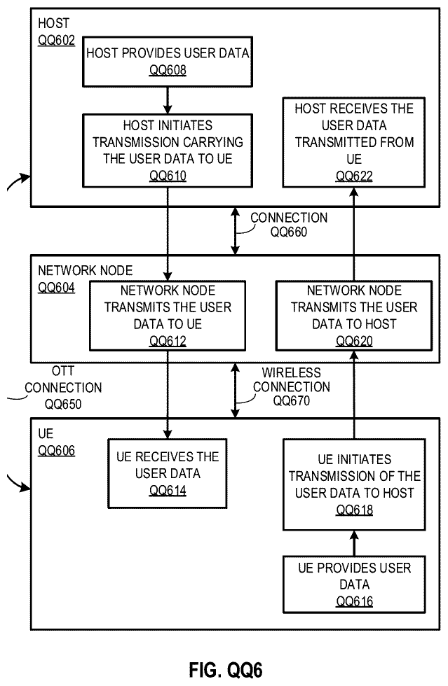

In a group of embodiments, this is achieved without changing the 3GPP convention of mapping ports to antennas. Thus, the mapping exemplified in FIG. 6 holds. Instead, the mapping of CSI-RS ports to TD-OCC (TD-CDM) is changed from NR.

Assuming beamformed CSI-RS resource of N ports, port n and n+N/2, n=3000, 3001, . . . 3000+N/2−1 for an N port CSI-RS are transmitted in the same wideband beam but mapped to different polarizations (different power amplifiers) according to 3GPP convention.

Ports n and n+N/2 are CDM multiplexed in the same subcarrier and separated using TD-OCC. Note that because a port is transmitted twice, in two OFDM symbols, there is a 3 dB coverage gain for the port without any need to split the power between the two ports due to the TD-OCC, because the two ports use different power amplifiers. Thus, the two ports may be transmitted with full power (full energy per resource element (EPRE)) despite the multiplexing in the same resource element (RE).

Because port n and n+N/2 use different PA, they may use the same REs (subcarrier) and two OFDM symbols to save RS overhead, and these two RS ports are maintained orthogonal using TD-OCC, e.g. [1 1] and [1 −1] for the two ports respectively, across the OFDM symbols in each subcarrier.

FIG. 7 illustrates an example of 4 CSI-RS ports from a total of 16 CSI-RS ports, where port 113 and 114 are transmitted with the same polarization and port 113+8 and 114+8, that is port 121 and port 122, are transmitted with the other polarization (according to 3GPP port to antenna mapping convention). A CSI-RS port is mapped to every 8th subcarrier and across two adjacent symbols in time. Ports n and n+8 are CDM multiplexed in the same subcarrier and separated using TD-OCC. Here, two groups of power amplifiers (PA) are defined group A and B. Group A transmits a beam using vertical polarization and group B using horizontal polarization. Here, port 113-120 are all transmitted through all the PAs in Group A but through none of the PAs in Group B.

As is seen in FIG. 7, CSI-RS ports 113 and 121 being associated with different polarizations, are multiplexed with different TD-OCCs, respectively [1,1] and [1,−1]. They share same REs in two consecutive OFDM symbols within a same subcarrier, as shown in FIG. 7, the first and second grids (each RE belong to a OFDM symbol) in the first, the ninth and seventeenth rows (each row corresponding to a subcarrier) in the radio resource grid tables. Note that the two tables of radio resource grid tables on the right side of the figure map to the same time-frequency resource. Similarly, CSI-RS ports 114 and 122 being associated with different polarizations are multiplexed with different TD-OCCs, respectively [1,1] and [1,−1]. They share same two REs of the first and second grids in the second, the tenth and eighteenth rows (each row corresponding to a subcarrier) in the radio resource grids.

Thus, by repeating the transmission of the port twice in two OFDM symbols, as in FIG. 7, the received power of that port is increased 3 dB under the condition that the transmit power per port is not reduced when the TD-OCC is applied to multiplex with the ports 121-129. But because these ports use separate groups of PA, there is no need to split the power between the ports. Accordingly, better coverage is achieved by repetition without increasing the CSI-RS overhead (the overhead remains on average 1 port/RE).

To summarize, port 3000 . . . 3000+N/2−1 use a TD-OCC of [1 1] and port 3000+N/2 . . . 3000+N−1 use a TD-OCC of [1 −1]. This is one specification impact of particular embodiments and this is different to how the NR and LTE specification is described.

The first group of embodiments would not change the 3GPP convention of mapping ports to antennas, meaning that both TD-OCC and FD-OCC can be used simultaneously. Taking FIG. 7 as an example, Ports 113, 114, 121, 122 formulate a group of CSI-RS ports, while Ports 113 and 121 still formulate a pair of CSI-RS ports as described above, and so as Ports 114 and 122. Ports 113 and 114 associated with vertical polarization are transmitting through PA group A and Ports 121 and 122 associated with horizontal polarization are transmitting through PA group B. All the 4 ports in the group are mapped to the same 4 REs in two consecutive OFDMs in subcarrier #1 and subcarrier #2 (as shown the first row in both radio resource grid tables), while Ports 113 and 121 are separated by TD-OCC and in meanwhile Ports 113 and 114 are separated by FD-OCC.

In another group of embodiments, ensuring that CSI-RS ports that are mapped with the TD-OCC (TD-CDM) mapping are not transmitted through the same power amplifier is achieved by changing the 3GPP convention of mapping ports to antennas. The mapping of CSI-RS ports to CDM groups is changed from NR. According to FIG. 6, port n and n+N/2 maps to different polarizations. If the convention of FIG. 6 is changed so that port n, n+1 for n=3000, 3002, 3004, . . . maps to different polarizations, then the same effect as in the first group of embodiments is achieved. In these embodiments, the codebook design needs to be restructured, because the codebooks in NR assume FIG. 6 conventions.

Note that even if NR and LTE currently support up to N=32 ports, particular embodiments may be used for N>32 ports, for example N=64 or N=128 ports.

According to another aspect of the disclosure, a communication system is herein provided. In an example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of Figure QQ1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in Figure QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in Figure QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in Figure QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Example implementations, in accordance with various embodiments, of the UE (such as a UE QQ112a of Figure QQ1 and/or UE QQ200 of Figure QQ2), network node (such as network node QQ110a of Figure QQ1 and/or network node QQ300 of Figure QQ3), and host (such as host QQ116 of Figure QQ1 and/or host QQ400 of Figure QQ4) discussed in the preceding paragraphs will now be described with reference to Figure QQ6.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of Figure QQ1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be understood that it would be unduly repetitious and obfuscating to literally describe and illustrate every combinations and sub-combinations of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combinations or subcombinations.

Some embodiments may include one or more of the following:

### Group A Embodiments

1. A method performed by a wireless device, the method comprising:
   obtaining a channel state information reference signal (CSI-RS) configuration where CSI-RS ports that are mapped with the time division orthogonal cover code (TD-OCC) (time domain code division multiplexing (TD-CDM)) mapping are not transmitted through the same power amplifier; and
   receiving a CSI-RS according to the CSI-RS configuration where full power is used for CSI-RS ports that are mapped with the TD-OCC (TD-CDM) mapping.
2. The method of the previous embodiment, wherein CSI-RS ports that are mapped with the TD-OCC (TD-CDM) mapping are not associated with the same antenna polarization.
3. A method performed by a wireless device, the method comprising:
   any of the wireless device steps, features, or functions described above, either alone or in combination with other steps, features, or functions described above.
4. The method of the previous embodiment, further comprising one or more additional wireless device steps, features or functions described above.
5. The method of any of the previous embodiments, further comprising:
   providing user data; and
   forwarding the user data to a host computer via the transmission to the base station.

### Group B Embodiments

6. A method performed by a base station, the method comprising:
   a. transmitting, to a wireless device, a channel state information reference signal (CSI-RS) configuration where CSI-RS ports that are mapped with the time division orthogonal cover code (TD-OCC) (time domain code division multiplexing (TD-CDM)) mapping are not transmitted through the same power amplifier; and
   b. transmitting CSI-RS to the wireless device according to the CSI-RS configuration where full power is used for CSI-RS ports that are mapped with the TD-OCC (TD-CDM) mapping.
7. The method of the previous embodiment, wherein CSI-RS ports that are mapped with the TD-OCC (TD-CDM) mapping are not associated with the same antenna polarization.
8. A method performed by a base station, the method comprising:
   any of the steps, features, or functions described above with respect to base station, either alone or in combination with other steps, features, or functions described above.
9. The method of the previous embodiment, further comprising one or more additional base station steps, features or functions described above.
10. The method of any of the previous embodiments, further comprising:
   obtaining user data; and
   forwarding the user data to a host computer or a wireless device.

### Group C Embodiments

11. A mobile terminal comprising:
   processing circuitry configured to perform any of the steps of any of the Group A embodiments; and
   power supply circuitry configured to supply power to the wireless device.
12. A base station comprising:
   processing circuitry configured to perform any of the steps of any of the Group B embodiments;
   power supply circuitry configured to supply power to the wireless device.
13. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
14. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
15. The communication system of the pervious embodiment further including the base station.
16. The communication system of the previous 2 embodiments, further including the UE, wherein the UE is configured to communicate with the base station.
17. The communication system of the previous 3 embodiments, wherein:
   the processing circuitry of the host computer is configured to execute a host application, thereby providing the user data; and
   the UE comprises processing circuitry configured to execute a client application associated with the host application.
18. A method implemented in a communication system including a host computer, a base station and a user equipment (UE), the method comprising:
   at the host computer, providing user data; and
   at the host computer, initiating a transmission carrying the user data to the UE via
   a cellular network comprising the base station, wherein the base station performs any of the steps of any of the Group B embodiments.
19. The method of the previous embodiment, further comprising, at the base station, transmitting the user data.
20. The method of the previous 2 embodiments, wherein the user data is provided at the host computer by executing a host application, the method further comprising, at the UE, executing a client application associated with the host application.
21. A user equipment (UE) configured to communicate with a base station, the UE comprising a radio interface and processing circuitry configured to performs any of the previous 3 embodiments.
22. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
23. The communication system of the previous embodiment, wherein the cellular network further includes a base station configured to communicate with the UE.
24. The communication system of the previous 2 embodiments, wherein:
   the processing circuitry of the host computer is configured to execute a host application, thereby providing the user data; and
   the UE's processing circuitry is configured to execute a client application associated with the host application.
25. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
26. The method of the previous embodiment, further comprising at the UE, receiving the user data from the base station.
27. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
28. The communication system of the previous embodiment, further including the UE.
29. The communication system of the previous 2 embodiments, further including the base station, wherein the base station comprises a radio interface configured to communicate with the UE and a communication interface configured to forward to the host computer the user data carried by a transmission from the UE to the base station.
30. The communication system of the previous 3 embodiments, wherein:
   the processing circuitry of the host computer is configured to execute a host application; and
   the UE's processing circuitry is configured to execute a client application associated with the host application, thereby providing the user data.
31. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
32. A method implemented in a communication system including a host computer, a base station and a user equipment (UE), the method comprising:
   at the host computer, receiving user data transmitted to the base station from the UE, wherein the UE performs any of the steps of any of the Group A embodiments.
33. The method of the previous embodiment, further comprising, at the UE, providing the user data to the base station.
34. The method of the previous 2 embodiments, further comprising:
   at the UE, executing a client application, thereby providing the user data to be transmitted; and
   at the host computer, executing a host application associated with the client application.
35. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
36. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
37. The communication system of the previous embodiment further including the base station.
38. The communication system of the previous 2 embodiments, further including the UE, wherein the UE is configured to communicate with the base station.
39. The communication system of the previous 3 embodiments, wherein:
   the processing circuitry of the host computer is configured to execute a host application;
   the UE is configured to execute a client application associated with the host application, thereby providing the user data to be received by the host computer.
40. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
41. The method of the previous embodiment, further comprising at the base station, receiving the user data from the UE.
42. The method of the previous 2 embodiments, further comprising at the base station, initiating a transmission of the received user data to the host computer.

1. A method performed in a wireless device, comprising:
obtaining a CSI-RS configuration indicating that a pair of CSI-RS ports of a transmitter being associated with different antenna polarizations are multiplexed with different TD-OCCs; and
receiving, according to the CSI-RS configuration, the pair of CSI-RS ports being multiplexed with different TD-OCCs that share same resource elements.

2. Method according to claim 1, wherein the pair of CSI-RS ports are CSI-RS port n and CSI-RS port n+N/2, where N is a total number of CSI-RS ports of the transmitter and N is an integer larger than 4.

3. Method according to claim 1, wherein the pair of CSI-RS ports are transmitted through different power amplifier groups.

4. Method according claim 1, wherein receiving the pair of CSI-RS ports comprises: receiving the pair of CSI-RS ports in two OFDM symbols within a same subcarrier.

5. Method according to claim 4, wherein the pair of CSI-RS ports are multiplexed with two different TD-OCCs over two consecutive OFDM symbols.

6. Method according to claim 1, wherein each of the pair of CSI-RS ports is simultaneously multiplexed with a FD-OCC over two adjacent subcarriers, and the method further comprising: receiving another pair of CSI-RS ports being associated with different antenna polarizations, wherein each of the other pair of ports is multiplexed with a different FD-OCC from the FD-OCC being multiplexed with the CSI-RS port in the pair of CSI-RS ports where the two CSI-RS ports are associated with same antenna polarization.

7. Method according to claim 1, wherein the TD-OCC has a length of 2.

8. Method according to claim 1, wherein the received CSI-RS ports are in a same spatial beam.

9. A method performed in a network node, comprising:
transmitting a CSI-RS configuration to a wireless device, indicating a pair of CSI-RS ports being associated with different antenna polarizations are multiplexed with different TD-OCCs; and
transmitting, the pair of CSI-RS ports being multiplexed with different TD-OCCs that share same resource elements.

10. Method according to claim 9, wherein the pair of CSI-RS ports are CSI-RS port n and CSI-RS port n+N/2, where N is a total number of CSI-RS ports and Nis an integer larger than 4.

11. Method according to claim 9, wherein the pair of CSI-RS ports are transmitted through different power amplifier groups.

12. Method according to claim 9, wherein the pair of CSI-RS ports are transmitted in two consecutive OFDM symbols within a same subcarrier.

13. Method according to claim 9, wherein each of the pair of CSI-RS ports is simultaneously multiplexed with a FD-OCC over two adjacent subcarriers, and the method further comprising: transmitting another pair of CSI-RS ports being associated with different antenna polarizations, wherein each of the other pair of ports is multiplexed with a different FD-OCC from the FD-OCC being multiplexed with the CSI-RS port in the pair of CSI-RS ports where the two CSI-RS ports are associated with same antenna polarization.

14. Method according to claim 13, wherein the two CSI-RS associated with same antenna polarization being multiplexed with different FD-OCCs are transmitted through a same power amplifier group.

15. A wireless device, comprising:
an antenna configured to transmit and receive wireless signals;
a memory, and a processing circuitry being configured to process instructions and data stored in the memory, whereby the wireless device is operative to perform the method according to claim 1.

16. (canceled)

17. The wireless device according to claim 15, wherein the pair of CSI-RS ports are CSI-RS port n and CSI-RS port n+N/2, where N is a total number of CSI-RS ports of the transmitter and N is an integer larger than 4.

18. The wireless device according to claim 15, wherein the wireless device operable to receive the pair of CSI-RS ports comprises the wireless device operable to receive the pair of CSI-RS ports in two OFDM symbols within a same subcarrier.

19. The wireless device according to claim 18, wherein the pair of CSI-RS ports are multiplexed with two different TD-OCCs over two consecutive OFDM symbols.

20. The wireless device according to claim 15:
wherein each of the pair of CSI-RS ports is simultaneously multiplexed with a FD-OCC over two adjacent subcarriers, and
the wireless device is further operable to receive another pair of CSI-RS ports being associated with different antenna polarizations, wherein each of the other pair of ports is multiplexed with a different FD-OCC from the FD-OCC being multiplexed with the CSI-RS port in the pair of CSI-RS ports where the two CSI-RS ports are associated with same antenna polarization

21. The wireless device according to claim 15, wherein the received CSI-RS ports are in a same spatial beam.
